(19) United States
(12) Patent Application Publication
(10) Pub. No.: US 2008/0067032 A1
(43) Pub. Date: Mar. 20, 2008

(54) VENDING MACHINE SYSTEM

(75) Inventors: Thorsten Schneider, Apensen (DE); Horst Buschmann, Harsefeld (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: National Rejectors, Inc. GmbH, Buxtehude (DE)

(21) Appl. No.: 11/752,456

(22) Filed: May 23, 2007

(30) Foreign Application Priority Data
Sep. 16, 2006 (DE) 20 2006 014 221.5

(51) Int. Cl. G06F 19/00; G07F 5/00; G07F 9/00

(52) U.S. Cl. 194/217; 194/302

(57) ABSTRACT

Vending machine system with a vending machine which comprises an interface for a communication with a coin validator/money changer and a counterfeit money detector/recycler, a communication interface being provided between the money changer and the recycler and an audit unit being provided in the vending machine with a communication interface for reading data of the vending machine, characterised in that a second audit unit is provided which is connected to the communication interface of the first audit unit, the second audit unit is connected to the connection of the money changer and the recycler as well as a communication interface for reading data from the vending machine, money changer and counterfeit money detector.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

A vending machine generally contains a coin validator/money changer (hereinafter: money changer) for validity testing inserted coins and for dispensing change. So that the vending machine is also able to accept bank notes, it is provided with a counterfeit money detector. It is further known also to provide the counterfeit money detector with a money return device, a so-called recycler. It is understood that, with two such peripheral devices, the first fulfils the primary function and the second fulfils the secondary function. Generally, the money changer undertakes the leading role.

Between the vending machine and the peripheral devices there is an interface for a communication which generally takes place according to the so-called MDB protocol. The data of the money changer and the counterfeit money detector are supplied to the vending machine and the vending machine has an audit unit from which the vending machine data, as well as the data for the money changer and the counterfeit money detector, are able to be read and namely generally by an external read-out device, such as a PC or the like.

Conventional vending machines are not able to control the return of notes from a recycler. Therefore—as mentioned above—a communication interface is provided between the money changer and the recycler, via which the money changer is able to provide information to the recycler for dispensing bank notes as change. For the vending machine, it is as if the change supply of the recycler is an additional coin tube. If a coin tube with the same value of coin as a bank note exists, the recycler supply is added to the tube contents. The vending machine can, therefore, only ‘assume’ that coins from the money changer are paid out, even when bank notes are dispensed from the recycler.

By means of the disclosed method, the audit data are falsified in the vending machine to such an extent that the vending machine ‘believes’ that the inserted bank notes are sorted into the cash box of the counterfeit money detector. In reality, however, a portion of the bank notes is paid out as change. This leads to discrepancies when auditing the vending machine if both peripheral devices, the money changer and the counterfeit money detector, are considered separately. The totals of the two devices coincide, but it is not possible to consider separately the money changer on the one hand and the counterfeit money detector on the other hand. From the data read from the audit unit, no conclusions are able to be drawn about the individual operation of these two peripheral devices.

The object of the invention is to provide a vending machine system with a coin validator/money changer and a counterfeit money detector/recycler which allows separate auditing with regard to the number of the respective stored payment means of the recycler and money changer.

### BRIEF DESCRIPTION OF THE INVENTION

With the vending machine system according to the invention a second audit unit is provided which is connected to the communication interface of the first audit unit. The second audit unit is further connected to the connection of the money changer and the recycler and has a communication interface for reading data from the vending machine, money changer and recycler.

The second audit unit is provided with two communication lines. The second audit unit may be read by an external device, for example a data collection device, via one line. The audit unit in the vending machine may be read via the other line. In one embodiment of the invention, the second audit unit is incorporated into the money changer. If the money changer is read, firstly it requests the data from the first audit unit. The money changer data are added as additional data to the received vending machine data or the data of the vending machine are overwritten with the correct money changer data.

According to a further embodiment of the invention, the second audit unit is incorporated into the recycler In this case, the data relating to the money is stored in the recycler.

Finally, the second audit unit may be provided as a separate unit which, for example, is also accommodated in the housing of the vending machine. It is therefore also connected to the communication line between the recycler and the money changer. Additionally, the second audit unit is able to be connected to the communication interface of the vending machine.

### BRIEF DESCRIPTION OF SEVERAL VIEWS OF THE DRAWINGS

Three embodiments of the invention are described hereinafter by means of block diagrams.

FIG. 1 shows a block diagram of a first embodiment of a vending machine system according to the invention.

FIG. 2 shows a block diagram of a second embodiment of a vending machine system according to the invention.

FIG. 3 shows a block diagram of a third embodiment of a vending machine system according to the invention.

### DETAILED DESCRIPTION OF THE INVENTION

While this invention may be embodied in many different forms, there are described in detail herein a specific preferred embodiment of the invention, This description is an exemplification of the principles of the invention and is not intended to limit the invention to the particular embodiment illustrated

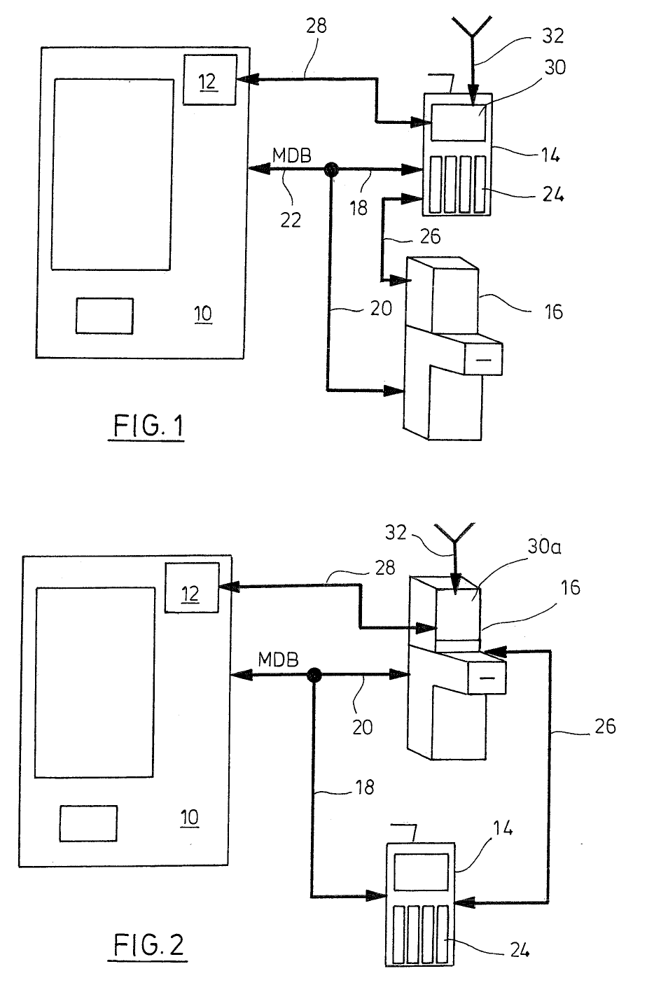

One respective vending machine 10 is shown in FIGS. 1 to 3 with a first internal audit unit 12. A coin validator/money changer 14 is further provided, as well as a counterfeit money detector/recycler 16. The vending machine 10 which is constructed and controlled in a conventional manner, has a communication interface via which it is connected to the money changer 14 and/or the counterfeit money detector/recycler. This is carried out in FIGS. 1 to 3 via the lines 18 and/or 20 as well as the common line 22. The communication takes place via the MDB protocol, known per se.

The coin validator/money changer tests the inserted coins for validity and stores the accepted coins in individual coin tubes which are indicated at 24. In the counterfeit money detector/recycler, the inserted bank notes are tested for validity and the accepted bank notes are stored in the recycler. In the event of overpayment, the processor, not shown, of the vending machine in FIG. 1 activates the money changer 14 and said money changer—connected via the connecting line 26 to the counterfeit money detector/recycler—controls the dispensing of change by dispensing coins and/or bank notes.

In FIG. 1 a second audit unit 30 is incorporated into the money changer 14. It is connected to the audit unit 12 in the vending machine 10 via a line 28. The first audit unit 12 is namely able to record all data from the peripheral devices, but is not able to assign said data to the peripheral devices. This is possible using the second audit unit 30 which contains both data from the audit unit 12 and from the money changer 14. Via a communication interface 32, the second audit unit 30 is able to be read by means of, for example, a data collection device. In this manner it is possible to display separately the data obtained relative to the money changer 14 and the recycler 16.

The same is the case in the embodiment according to FIG. 2, in which a second audit unit 30a is incorporated into the counterfeit money detector/recycler When data is requested from the second audit unit 30 and/or 30a, the money changer data and/or recycler data may be added as additional data to the received data of the audit unit 12 or the data of the vending machine 10 are overwritten with the correct money changer and/or recycler data.

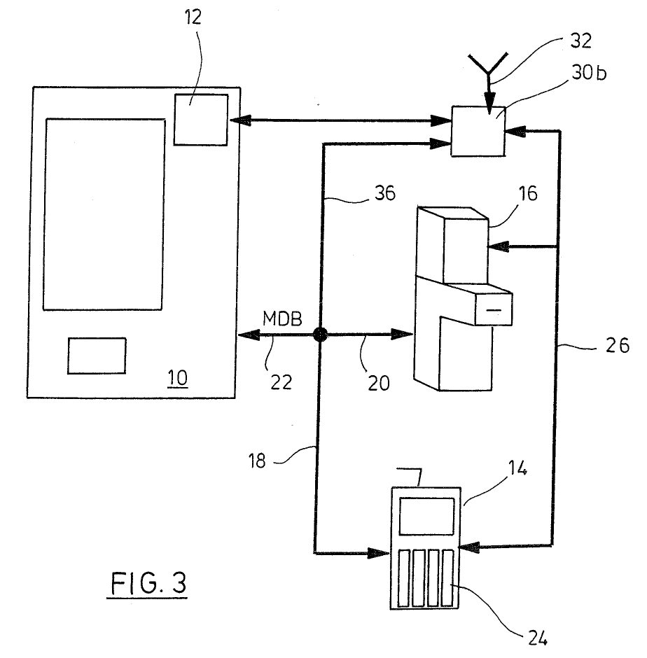

In the embodiment according to FIG. 3 a second audit unit 30b is arranged separately. Similar to the money changer 14 and the recycler 16, the unit 30b may also be accommodated in the housing of the vending machine 10. In the case of FIG. 3, the second audit unit 30b communicates both with the recycler 16 and also with the money changer 24. Furthermore, the audit unit 30b is connected via a line 36 to the MDB interface of the vending machine 10. With regard to the function of the second audit unit there is no difference from the function of the embodiment according to FIGS. 1 and 2.

With the development of new vending machine control systems, further solutions are conceivable which are able to solve the underlying problem of the invention without an additional audit unit.

A correction of the calculated data may then be carried out directly by the vending machine if the MDB protocol is extended by additional commands for the communication between the vending machine and the money changer. The money changer informs the vending machine, via the interface which is present, which bank notes have been conveyed into the cash box and/or into the money store of the recycler and how many bank notes have been paid out. The vending machine is than immediately able to correct its audit data.

A further solution is the direct activation of the recycler by the vending machine. The vending machine communicates directly with the recycler and thus obtains the information about which bank notes have been conveyed into the cash box and/or into the bank note store of the recycler. The paying-out of change from the recycler is also directly undertaken by the vending machine. Thus the correct audit data may be directly generated by the vending machine control system.

Both solutions, however, require an alteration to the software of the vending machine and are thus not suitable for older devices.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Vending machine system with a vending machine which comprises an interface for a communication with a coin validator/money changer and a counterfeit money detector/recycler, a communication interface being provided between the money changer and the recycler and an audit unit being provided in the vending machine with a communication interface for reading data of the vending machine, characterised in that a second audit unit (30, 30a, 30b) is provided which is connected to the communication interface of the first audit unit (12), the second audit unit (30, 30a, 30b) is connected to the connection of the money changer (14) and the recycler (16) as well as a communication interface for reading data from the vending machine, money changer and counterfeit money detector.

2. Vending machine system according to claim 1, characterised in that the second audit unit (30) is incorporated into the money changer (14).

3. Vending machine system according to claim 1, characterised in that the second audit unit (30a) is incorporated into the recycler (16).

4. Vending machine system according to claim 1, characterised in that the second audit unit (30b) is provided as a separate unit.

5. Vending machine system according to claim 4, characterised in that the second audit unit is connected to the communication interface of the vending machine.

6. Vending machine system according to claim 1, characterised in that the communication from the first and second audit unit is such that the money changer data from the second audit unit is added to the first audit unit or the vending machine data are overwritten with the correct money changer data.
